(19) United States
(12) Patent Application Publication
(10) Pub. No.: US 2008/0136771 A1
(43) Pub. Date: Jun. 12, 2008

(54) Backlight control circuit with primary and secondary switch units

(75) Inventors: Ying Chen, Shenzhen (CN); Jin-Liang Xiong, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignees: INNOCOM TECHNOLOGY (SHENZHEN) CO., LTD.; INNOLUX DISPLAY CORP.

(21) Appl. No.: 12/001,726

(22) Filed: Dec. 11, 2007

(30) Foreign Application Priority Data
Dec. 11, 2006 (TW) 95146225

(51) Int. Cl. H05B 37/00

(52) U.S. Cl. 345/102

(57) ABSTRACT

An exemplary backlight control circuit (20) includes a sampling circuit (210), a pulse width modulation integrated circuit (260), a primary switch unit (271), and two secondary switch units (272, 273) connected in series to the primary switch unit. The sampling circuit outputs voltage signals to control on-off states of the two secondary switch units. The two secondary switch units correspondingly control an on-off state of the primary switch unit, and the primary switch unit correspondingly controls an on-off state of the pulse width modulation integrated circuit.

### FIELD OF THE INVENTION

The present invention relates to a backlight control circuit with primary and secondary switch units, the backlight control circuit typically being used in a liquid crystal display (LCD).

### GENERAL BACKGROUND

LCDs are widely used in various modern information products, such as notebooks, personal digital assistants (PDAs), video cameras and the like. The wide usage of the LCD is due to its advantages such as portability, low power consumption, and low radiation. Because liquid crystal in an LCD does not emit any light itself, a backlight system is usually needed to enable the LCD to display images.

A typical backlight system includes a plurality of backlight lamps, an inverter circuit for driving the backlight lamps, and a backlight control circuit. The backlight control circuit is for feeding back currents of the backlight lamps and protecting the backlight system when an open circuit occurs in any of the backlight lamps.

FIG. 3 is an abbreviated diagram of a conventional backlight control circuit 10. The backlight control circuit 10 is typically installed in a backlight system (not shown). The backlight system is used together with an LCD, which are both installed in a product such as a notebook, a PDA, a video camera, etc. The backlight control circuit 10 includes four sampling circuits 110, 120, 130, 140, a pulse width modulation integrated circuit (PWM IC) 13, a switch circuit 170, a first input circuit 150, and a second input circuit 180.

Each sampling circuit 110, 120, 130, 140 includes a respective backlight lamp 111, 121, 131, 141 and a respective sampling output 112, 122, 132, 142. When an open circuit occurs in any backlight lamp 111, 121, 131, 141, the corresponding sampling output 112, 122, 132, 142 provides a low voltage.

The PWM IC 160 includes a current sense pin 161. If the current sense pin 161 has a low voltage, the PWM IC 160 controls the backlight system to switch to a protecting state.

The switch circuit 170 includes a first transistor 171, a second transistor 172, a current-limiting resistor 173, and a bias resistor 174. The first transistor 171 includes an emitter that is grounded, a collector electrically connected to the current sense pin 161 of the PWM IC 160, and a base. The base of the first transistor 171 and a collector of the second transistor 172 are electrically connected to a pin of the PWM IC 160 via the current-limiting resistor 173. The pin of the PWM IC 160 is used as a power supply for providing a voltage of 5V (volts). The second transistor 172 further includes an emitter that is grounded, and a base that is grounded via the bias resistor 174.

The first input circuit 150 includes two diodes 151, two current-limiting resistors 152, two filter capacitors 153, and two voltage-dividing resistors 154. Each diode 151 includes a negative terminal electrically coupled to the base of the second transistor 172 via a corresponding voltage-dividing resistor 154. In addition, the negative terminal of each diode 151 is grounded via a corresponding current-limiting resistor 152 and a corresponding filter capacitor 153, with the current-limiting resistor 152 and the filter capacitor 153 being connected in parallel to the negative terminal of the diode 151. A positive terminal of one of the diodes 151 is connected to the sampling output 112, and is used as a first input terminal. A positive terminal of the other diode 151 is connected to the sampling output 122, and is used as a second input terminal.

The second input circuit 180 includes a first resistor 181 and a second resistor 182. One terminal of the first resistor 181 is electrically connected to the current sense pin 161 of the PWM IC 160. The other terminal of the first resistor 181 is connected to the sampling output 132, and is used as a third input terminal. One terminal of the second resistor 182 is electrically connected to the current sense pin 161 of the PWM IC 160. The other terminal of the second resistor 182 is connected to the sampling output 142, and is used as a fourth input terminal.

Operation of the backlight control circuit 10 is as follows. When the backlight lamps 111, 121, 131, 141 of the sampling circuits 110, 120, 130, 140 are in normal working states, the sampling outputs 112, 122, 132, 142 output high voltages, respectively. The high voltages output by the sampling outputs 112, 122 cause the second transistor 172 to switch to an on-state after passing through the voltage-dividing resistors 154, thereby lowering the voltage of the base of the first transistor 171. Thus, the first transistor 171 is switched to an off-state. Moreover, the high voltages output by the sampling outputs 132, 142 are applied to the current sense pin 161 of the PWM IC 160 via the second input circuit 180.

When an open circuit occurs in either of the backlight lamps 111, 121, the corresponding sampling output 112, 122 provides a low voltage. The low voltage causes the second transistor 172 to switch to an off-state after passing through the diodes 151. The first transistor 171 then switches to an on-state according to the DC voltage outputted from the current sense pin 161. As a result, the current sense pin 161 of the PWM IC 160 is grounded via the first transistor 171. Then, the PWM IC 160 controls the backlight system to switch to a protecting state.

When an open circuit occurs in either of the backlight lamps 131, 141, the corresponding sampling output 132, 142 provides a low voltage. The low voltage causes the current sense pin 161 of the PWM IC 160 to be grounded via the first transistor 171. Then, the PWM IC 160 controls the backlight system to switch to the protecting state.

In a normal working state, the voltage applied to the base of the second transistor 172 is the sum of the voltages passing through the first and second input terminals, respectively. The sum of the voltages should be larger than the threshold voltage of the second transistor 172, so as to cause the second transistor 172 to switch to the on-state. When an open circuit occurs in either of the backlight lamps 111, 121, the voltage applied to the base of the second transistor 172 is the high voltage output from only one of the sampling outputs 112, 122. This high voltage should be less than the threshold voltage of the second transistor 172, so as to cause the second transistor 172 to switch to the off-state.

However, the operating current of each of the backlight lamps 111, 121, 131, 141 is prone to vary. When the backlight lamp 111 has a large current and an open circuit occurs in the backlight lamp 121, the voltage applied to the second transistor 172 via the first input terminal may still larger than the threshold voltage of the second transistor 172. That is, the second transistor 172 is liable to remain in an on-state. Therefore, the backlight control circuit 10 does not necessarily function to protecting the backlight system when an open circuit occurs in any of the backlight lamps 111, 121, 131, 141. Another example of this kind of problem is when the backlight lamp 121 has a large current and an open circuit occurs in the backlight lamp 111.

It is, therefore, desired to provide a backlight control circuit that can be used to overcome the above-described deficiencies.

### SUMMARY

In an exemplary embodiment, a backlight control circuit includes a sampling circuit; a pulse width modulation integrated circuit; a primary switch unit; and at least two secondary switch units connected in series to the primary switch unit. The sampling circuit outputs voltage signals to control on-off states of the at least two secondary switch units. The at least two secondary switch units correspondingly control on-off state of the primary switch unit, and the primary switch unit correspondingly controls an on-off state of the pulse width modulation integrated circuit.

Other novel features and advantages of the above-described circuit will become more apparent from the following detailed description when taken in conjunction with the accompanying drawings.

### BRIEF DESCRIPTION OF THE DRAWINGS

FIG. 1 is an abbreviated diagram of a backlight control circuit according to an exemplary embodiment of the present invention.

FIG. 2 is an abbreviated diagram of a backlight control circuit according to another exemplary embodiment of the present invention.

FIG. 3 is an abbreviated diagram of a conventional backlight control circuit.

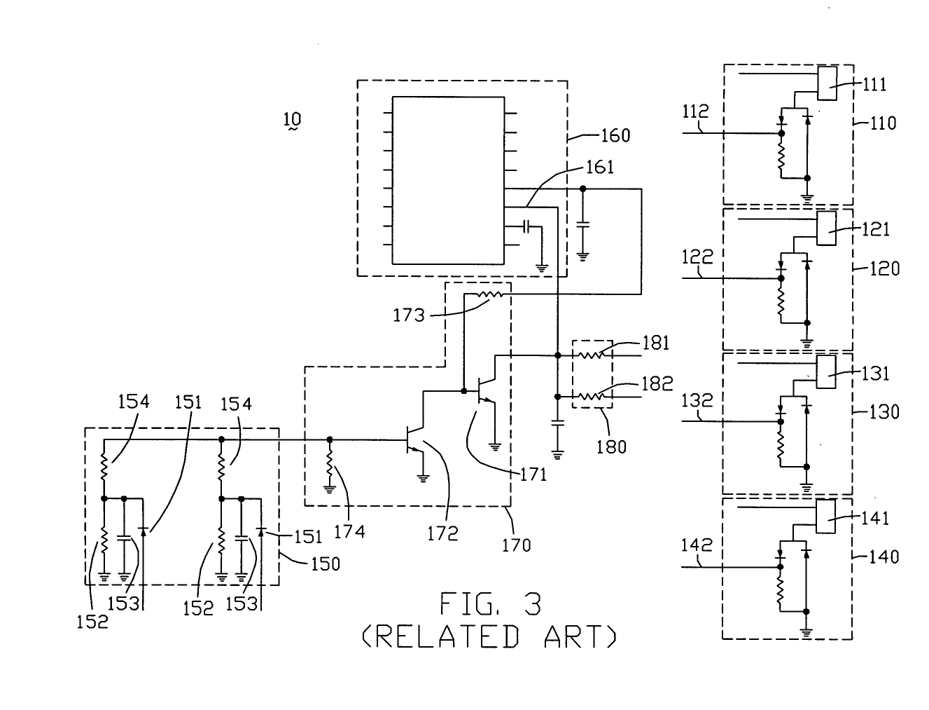

### DETAILED DESCRIPTION OF PREFERRED EMBODIMENTS

Reference will now be made to the drawings to describe preferred and exemplary embodiments of the present invention in detail.

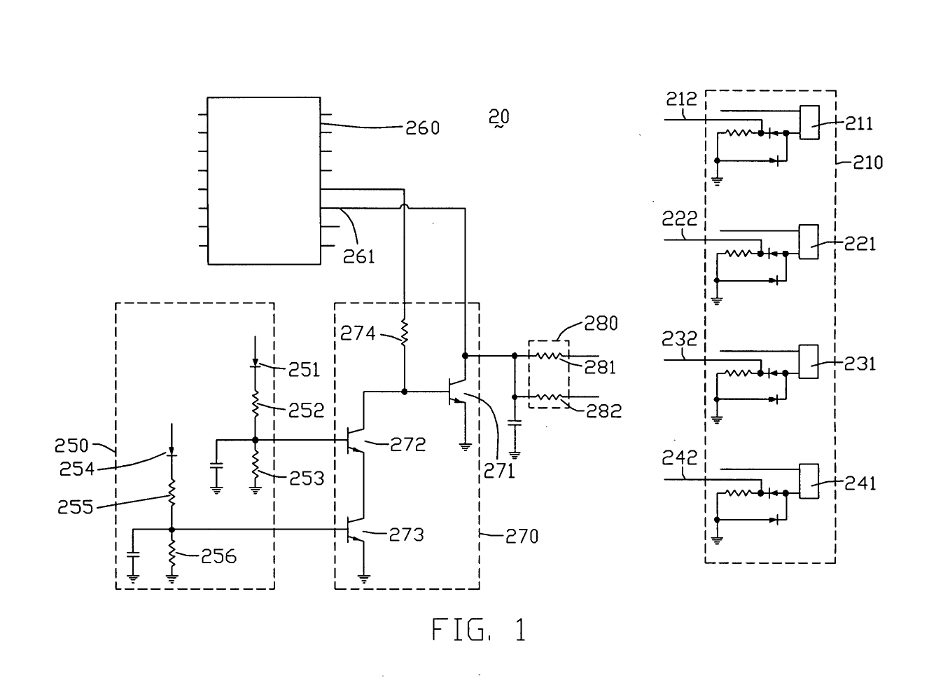

FIG. 1 is an abbreviated diagram of a backlight control circuit 20 according to an exemplary embodiment of the present invention. The backlight control circuit 20 is typically installed in a backlight system (not shown). The backlight system is used together with an LCD, which are both installed in a product such as a notebook, a PDA, a video camera, etc. The backlight control circuit 20 includes a sampling circuit 210, a pulse width modulation integrated circuit (PWM IC) 260, a switch circuit 270, an input circuit 250, and a feedback circuit 280. When an open circuit occurs in any of the first, second, third, or fourth backlight lamps 211, 221, 231, 241, the sampling circuit 210 causes a corresponding first, second, third, or fourth sampling output 212, 222, 232, 242 to provide a low voltage.

The PWM IC 260 includes a current sense pin 261. The PWM IC 260 controls the backlight system in which the backlight control circuit 20 is installed. In particular, if the current sense pin 261 has a low voltage, the PWM IC 260 controls the backlight system to switch to a protecting state.

The switch circuit 270 includes a primary transistor 271, a first secondary transistor 272, a second secondary transistor 273, and a current-limiting resistor 274. The primary transistor 271 includes an emitter that is grounded, a collector electrically connected to the current sense pin 261 of the PWM IC 260, and a base. The base of the primary transistor 271 and a collector of the first secondary transistor 272 are electrically connected to a power pin of the PWM IC 260 via the current-limiting resistor 274. The power pin of the PWM IC 260 is used as a power supply for providing a voltage of 5V (volts). The first secondary transistor 272 further includes an emitter electrically connected to a collector of the second secondary transistor 273, and an emitter that is grounded. The primary and secondary transistors 271, 272, 273 may be bipolar transistors.

The input circuit 250 includes a first diode 251, a first upper bias resistors 252, a first lower bias resistor 253, a second diode 254, a second upper bias resistor 255, and a second lower bias resistor 256. A positive terminal of the first diode 251 is electrically connected to the first sampling output 212, and is used as a first input terminal of the input circuit 250. A negative terminal of the first diode 251 is electrically connected to the base of the first secondary transistor 272 via the first upper bias resistor 252. Further, the base of the first secondary transistor 272 is grounded via the first lower bias resistor 253, and also grounded via a filter capacitor (not labeled). A positive terminal of the second diode 254 is electrically connected to the second sampling output 222, and is used as a second input terminal of the input circuit 250. A negative terminal of the second diode 254 is electrically connected to the base of the second secondary transistor 273 via the second upper bias resistor 255. Further, the base of the second secondary transistor 273 is grounded via the second lower bias resistor 256, and also grounded via a filter capacitor (not labeled).

The feedback circuit 280 includes a first resistor 281 and a second resistor 282. One terminal of the first resistor 281 is electrically connected to the current sense pin 261 of the PWM IC 260. The other terminal of the first resistor 281 is electrically connected to the third sampling output 232, and is used as a first input terminal of the feedback circuit 280. One terminal of the second resistor 282 is electrically connected to the current sense pin 261 of the PWM IC 260. The other terminal of the second resistor 282 is electrically connected to the fourth sampling output 242, and is used as a second input terminal of the feedback circuit 280.

Typical operation of the backlight control circuit 20 is as follows. When the backlight lamps 211, 221, 231, 241 of the sampling circuit 210 are in normal working states, the sampling outputs 212, 222, 232, 242 output high voltages, respectively. The values of the first upper resistor 252 and the first lower bias resistor 253 are predetermined, to enable the high voltage output by the first sampling output 212 to pass through the first diode 251 and cause the first secondary transistor 272 to switch to an on-state. Further, the values of the second upper resistor 255 and the second lower resistor 256 are predetermined, to enable the high voltage output by the second sampling output 222 to pass through the second diode 254 and cause the second secondary transistor 273 to switch to an on-state. Thus, a voltage of the base of the primary transistor 271 is lowered, and the primary transistor 271 is switched to an off-state. Furthermore, the high voltages output by the third and fourth sampling outputs 232, 242 are applied to the current sense pin 261 of the PWM IC 260 via the feedback circuit 280.

When an open circuit occurs in the first backlight lamp 211, the corresponding first sampling output 212 provides a low voltage. The low voltage causes the first secondary transistor 272 to switch to an off-state after passing through the first diode 251. That is, the base of the primary transistor 271 is disconnected from ground, and the primary transistor 271 then switches to an on-state due to the base thereof receiving the high voltage of 5V from the power pin of the PWM IC 260. As a result, a voltage of the current sense pin 261 of the PWM IC 260 is lowered. Then, the PWM IC 260 stops working, to control the backlight system to switch to a protecting state.

When an open circuit occurs in the second backlight lamp 221, the backlight control circuit 20 has an operation process similar to that described above in relation to an open circuit occurring in the first backlight lamp 211.

When an open circuit occurs in the third backlight lamp 231, the corresponding third sampling output 232 provides a low voltage. The low voltage causes a voltage of the current sense pin 261 of the PWM IC 260 to be lower. Then, the PWM IC 260 controls the backlight system to switch to the protecting state.

When an open circuit occurs in the fourth backlight lamp 241, the backlight control circuit 20 has an operation process similar to that described above in relation to an open circuit occurring in the third backlight lamp 231.

Unlike in a conventional backlight control circuit, the input circuit 250 of the backlight control circuit 20 includes a first input terminal and a second input terminal for receiving voltages. The voltages passing through the first and second input terminals are used to control the on-off states of the first and second secondary transistors 272, 273, respectively. The first and second secondary transistors 272, 273 are connected in series, and cooperatively control the on-off state of the primary transistor 271. When an open circuit occurs in either of the first and second backlight lamps 211, 221, a corresponding one of the first and second secondary transistors 272, 273 is switched to an off-state, so as to reliably cause the primary transistor 271 to switch to an off-state. That is, the backlight control circuit 20 has a dependable protection function.

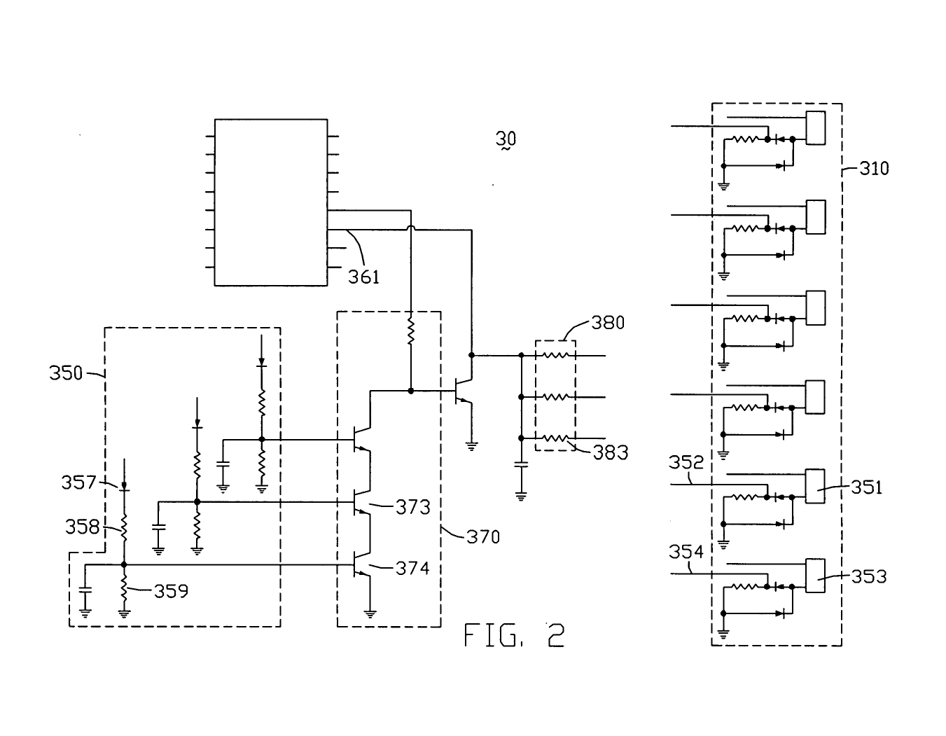

Referring to FIG. 2, an abbreviated diagram of a backlight control circuit 30 according to another exemplary embodiment of the present invention is shown. The backlight control circuit 30 has a structure similar to that of the backlight control circuit 20. However, a sampling circuit 310 further includes a fifth backlight lamp 351, a sixth backlight lamp 353, a fifth sampling output 352, and a sixth sampling output 354. A switch circuit 370 further includes a third secondary transistor 374. An input circuit 350 further includes a third diode 357, a third upper bias resistor 358, and a third lower bias resistor 359. A feedback circuit 380 further includes a third resistor 383.

When an open circuit occurs in either of the fifth or sixth backlight lamps 351, 353, the corresponding sampling output 352, 354 provides a low voltage. The third secondary transistor 374 includes a base that is grounded via the third lower bias resistor 359, a collector, and an emitter electrically connected between an emitter of the second secondary transistor 373 and ground in series. A positive terminal of the third diode 357 is electrically connected to the third sampling output 352, and is used as a third input terminal of the input circuit 350. A negative terminal of the third diode 357 is electrically connected to the base of the third secondary transistor 374 via the third upper bias resistor 358. One terminal of the third resistor 383 is electrically connected to the current sense pin 361. The other terminal of the third resistor 383 is electrically connected to the sixth sampling output 354, and is used as a third input terminal of the feedback circuit 380.

Various modifications and alterations are possible within the ambit of the invention herein. For example, the primary and secondary transistors may be replaced by other switch elements, such as field-effect transistors. Such field-effect transistors are preferably metal-oxide-semiconductor field effect transistors. Moreover, when the number of lamps is greater than six, the corresponding backlight control circuit only needs to incorporate at least one corresponding additional switch element and diode, and corresponding additional resistors.

It is to be further understood that even though numerous characteristics and advantages of preferred and exemplary embodiments have been set out in the foregoing description, together with details of the structures and functions of the embodiments, the disclosure is illustrative only; and that changes may be made in detail within the principles of present invention to the full extent indicated by the broad general meaning of the terms in which the appended claims are expressed.

What is claimed is:

1. A backlight control circuit, comprising:
a sampling circuit;
a pulse width modulation integrated circuit;
a primary switch unit; and
at least two secondary switch units connected in series to the primary switch unit;
wherein the sampling circuit outputs voltage signals to control on-off states of the at least two secondary switch units, the at least two secondary switch units correspondingly control an on-off state of the primary switch unit, and the primary switch unit correspondingly controls an on-off state of the pulse width modulation integrated circuit.

2. The backlight control circuit as claimed in claim 1, wherein the at least two secondary switch units are two secondary switch units.

3. The backlight control circuit as claimed in claim 1, wherein the at least two secondary switch units are three secondary switch units.

4. The backlight control circuit as claimed in claim 2, wherein the primary and secondary switch units are primary and secondary transistors.

5. The backlight control circuit as claimed in claim 4, wherein the primary and secondary transistors are field effect transistors.

6. The backlight control circuit as claimed in claim 5, wherein the field effect transistors are metal-oxide-semiconductor field effect transistors

7. The backlight control circuit as claimed in claim 4, wherein the at least two secondary transistors comprise a first secondary transistor and a second secondary transistor, the sampling circuit comprises a first backlight lamp, a first sampling output, a second backlight lamp, and a second sampling output, the pulse width modulation integrated circuit comprises a current sense pin, the primary transistor comprises an emitter that is grounded, a collector connected to the current sense pin of the pulse width modulation integrated circuit, and a base connected to a power source, the first secondary transistor comprises a base connected to the first sampling output, a collector connected to the base of the primary transistor, and an emitter connected to the collector of the second secondary transistor, and the second secondary transistor comprises a base connected to the second sampling output, and an emitter that is grounded.

8. The backlight control circuit as claimed in claim 7, wherein when an open circuit occurs in either of the first and second backlight lamps, the corresponding first or second sampling output provides a low voltage, a voltage of the current sense pin is correspondingly lowered, and the pulse width modulation integrated circuit correspondingly stops working.

9. The backlight control circuit as claimed in claim 7, further comprising a first diode, a first upper bias resistor, a first lower bias resistor, a second diode, a second upper bias resistor, and a second lower bias resistor, the first diode and the first upper bias resistor being connected in series between the first sampling output and the base of the first secondary transistor, the first lower bias resistor being connected between the base of the first secondary transistor and ground, the second diode and the second upper bias resistor being connected in series between the second sampling output and the base of the second secondary transistor, and the second lower bias resistor being connected between the base of the second secondary transistor and ground.

10. The backlight control circuit as claimed in claim 7, wherein the base of the first secondary transistor is grounded via a filter capacitor, and the base of the second secondary transistor is grounded via a filter capacitor.

11. The backlight control circuit as claimed in claim 7, further comprising a third backlight lamp, a third sampling output, a fourth backlight lamp, and a fourth sampling output, wherein when an open circuit occurs in either of the third and fourth backlight lamps, the corresponding third or fourth sampling output provides a low voltage.

12. The backlight control circuit as claimed in claim 11, further comprising a feedback circuit, the feedback circuit comprising a first resistor and a second resistor, one terminal of the first resistor being connected to the current sense pin of the pulse width modulation integrated circuit, the other terminal of the first resistor being connected to the third sampling output, one terminal of the second resistor being connected to the current sense pin of the pulse width modulation integrated circuit, and the other terminal of the second resistor being connected to the fourth sampling output.

13. The backlight control circuit as claimed in claim 7, wherein the at least two secondary transistors further comprise a third secondary transistor, the sampling circuit further comprises a third backlight lamp and a third sampling output, and the third transistor comprises a base connected to the third sampling output, a collector, and an emitter connected between the emitter of the second secondary transistor and ground.

14. The backlight control circuit as claimed in claim 13, wherein when an open circuit occurs in the third backlight lamp, the third sampling output provides a low voltage.

15. The backlight control circuit as claimed in claim 13, further comprising a diode, an upper bias resistor, and a lower bias resistor, the diode and the upper bias resistor being connected in series between the third sampling output and the base of the third secondary transistor, and the lower bias resistor being connected between the base of the third secondary transistor and ground.

16. The backlight control circuit as claimed in claim 13, wherein the base of the third secondary transistor is grounded via a filter capacitor.

17. The backlight control circuit as claimed in claim 13, further comprising a fourth backlight lamp and a fourth sampling output, wherein when an open circuit occurs in the fourth backlight lamp, the fourth sampling output provides a low voltage.
